(19) United States
(12) Patent Application Publication
(10) Pub. No.: US 2004/0132449 A1
(43) Pub. Date: Jul. 8, 2004

(54) Method and apparatus for permitting a mobile station to operate in a visited network

(76) Inventor: Benjamin Kowarsch, Tokyo (JP)

Correspondence Address: John C Kerins, Miles & Stockbridge, 1751 Pinnacle Drive Suite 500, McLean, VA, 22102-3833, US

(21) Appl. No.: 10/297,712

(22) PCT Filed: Jun. 6, 2001
(86) PCT No.: PCT/AU01/00672

(30) Foreign Application Priority Data
Jun. 9, 2000 (AU) PQ 8094
Aug. 28, 2000 (AU) PQ 9701

(51) Int. Cl. H04Q 7/20

(52) U.S. Cl. 455/432.1; 455/422.1; 455/433

(57) ABSTRACT

A method and apparatus are provided which permit a mobile station from a home network to operate in a visited network, the method including monitoring an attempt by the mobile station to sign onto said visited network to determine whether a predetermined condition is met, and automatically initiating the creation of an account for the mobile station in the visited network if the predetermined condition is met.

### FIELD OF THE INVENTION

The present invention relates to a method and apparatus for permitting a mobile station to operate in a visited network.

### BACKGROUND OF THE INVENTION

These days it is increasingly common for people to move from one country to another while still wanting to keep in touch by telephone and to be able to make telephone calls irrespective of where they are. Thus, a facility has been devised which allows a person whose mobile phone (referred to as mobile station in the industry) is subscribed in a home network to visit another network and make telephone calls in this network. This facility is known as “roaming”. That is, when a mobile phone is operating in a visited network it is roaming from its home network.

It will be apparent that roaming raises technical problems as to how to charge for calls made by a roaming mobile phone in a visited network. The visited network needs to redeem its costs as well as making an appropriate profit. Therefore, typically the visited network will only allow a phone visiting the network to make calls if the visited network has an agreement with the home network that the home network will cover costs incurred by the roaming mobile phone when it is in the visited network—i.e. that the visiting phone is allowed to incur costs on behalf of the home network.

As a result, the onus is on the home network to control whether (or the extent to which) a mobile phone is allowed to operate when it visits another network. The problem that the home network faces is ensuring that it obtains payment for costs incurred by the mobile phone operating in the visited network. This poses a very genuine risk to a mobile phone company because mobile phones can incur significant costs, particularly, as a mobile phone user in a foreign country will often make expensive international phone calls to their home country. Further, the situation is different to when a customer defaults on charges in the home network because the home network can write these charges off at cost whereas charges incurred in a visited network must be paid in full under the terms of the agreement between a visited and a home network. The matter is additionally complicated because there can be some delay between calls being made in the visited network and then being charged to the user's account in the home network. That is, there will be a first delay between when those call charges are charged by the visited network to the home network and then a second delay before those charges are passed on to the owner of the mobile phone. This delay increases the chance that a mobile phone owner will default on payment.

These factors lead to home networks developing strategies to deal with their customers' desire to use their phones in other networks they visit which can unreasonably affect their customers' prospects of using their phone in a visited network.

Home networks tend to charge roaming calls at a premium because of the increased risk of non-payment. This is clearly disadvantageous to consumers who are already disadvantaged because the visited network will tend to charge their calls at a higher rate because they are not receiving a regular payment from the owner of the roaming mobile phone. This is in contrast to operation within a home network where a mobile phone user typically pays a fixed monthly cost plus call charges.

Home networks usually have more stringent credit requirements for allowing a user to enable roaming. The home network may carry out a credit check and may ask the user to pay a deposit. In some circumstances home networks will only allow a mobile phone to roam if additional arrangements are in place to settle charges incurred in the visited network. This may require the owner of the mobile phone to supply the home network with the authority to charge their credit card directly before they will enable the roaming facility. Thus, unless a user has made prior arrangements with their home network to enable the roaming facility they may not be able to roam in a visited network.

A further problem is that the roaming model does not interact with all other payment models. A popular method of paying for a mobile phone is a pre-paid mobile phone system where a user purchases credits by way of a voucher system or otherwise and then has this credit reduced as they use their phone in the home network. Such a payment system does not work optimally with roaming because of the delay between charges being incurred in a foreign country and being settled in the home country. Thus, pre-paid phones are usually not enabled for roaming because of the risk that there will be no credits allocated to the phone when the charges are received from the visited network. Pre-paid mobile phones are becoming increasingly popular because once a person has paid for the starter kit and initial credits they do not have to contract to use their phone for a fixed period as is generally the case with other mobile phones. Further, a person using a pre-paid phone can monitor closely how much they spend on their calls. There is also a reduced risk to the network because they receive up-front payment. However, a pre-paid system is not appropriate if a person moves between a number of networks as it will be necessary for them to buy a starter kit in each network they visit. Obviously, unless the mobile phone user plans to spend considerable time in the visited network this is not economical. Further, each starter kit comes with a new phone number which is inconvenient for the user as they must advise their friends and associates of the new number to be able to receive calls.

In one prior art pre-paid system each user's credit is stored in a central database. In some such pre-paid systems, each time the user uses their mobile phone to make a call, a call connection request is relayed via a mobile base station to a mobile switching centre (MSC), the MSC routes the call via a service node associated with the pre-paid system located between the MSC voice ports and the destination so that the service node can take control over any traffic relating to calls initiated from phones which are subscribed to the pre-paid service. The MSC will allow the phone to make calls and when it attempts to route a call to a destination, the service node checks the balance of the user's credit to determine whether the call is allowed or not. If it is, the service node will let the call pass through, if not, it will terminate the call and usually connect the user to a recorded message telling them why the call cannot be completed. The service node operates to maintain the appropriate account balance for the phone; this also allows for calls to be terminated instantly if the credit associated with the phone is exhausted while the call is in progress. All the MSC needs to know is that anyone who is a pre-paid user will be routed to the service node for further processing. The MSC tells the service node any routing instructions necessary to connect the call.

In an alternative prior art pre-paid system, the credit of each user is stored locally on the mobile phone rather than by an element of the mobile phone network. Such a pre-paid system is called a Local Storage system, whereas a system that stores each user's credit in a central database is called a Remote Storage system.

In a Local Storage system, credit is stored on a credit register located within the mobile phone itself. Commonly, such a credit register resides on a special SIM card for use with the pre-paid system. Alternatively, the credit register can reside in the firmware of a custom built mobile phone for use with the pre-paid system. To add credit to the credit register a voucher is bought by the user, and validated by the network when the user dials a special phone number and enters a voucher number or a voucher PIN code. The details of the voucher are then sent to the pre-paid platform, which checks to determine whether the voucher is valid. If the voucher is valid, the pre-paid platform sends a credit notification signal—for example, in the form of an encrypted short message—to the mobile phone with instructions to add the amount of credit represented by the voucher to the credit register located in the mobile phone. Thus, it will be apparent that such an arrangement includes logic, which allows the mobile phone to alter the credit register directly. As described above, such logic is typically located on the SIM card.

When the user of the mobile phone initiates a call, the charging logic determines whether there is sufficient credit in the credit register to allow the user to make a phone call. For each call the network sends a Charging Advice Information (CAI) signal to the mobile phone. The CAI signal informs the mobile phone about the charges that will apply for the call. As the user incurs phone charges while the call is in progress, Advice of Charge (AoC) signals are generated by the network and sent to the mobile phone whereafter the charging logic deducts credit from the credit register in accordance with the information obtained from the CAI signal. This mechanism is referred to as Advice of Charge Charging (AoCC).

In such a pre-paid system, the mobile switching centre (MSC) is commissioned so that it sends AoC signals to all pre-paid mobile phones. The MSC determines from the home location registry (HLR) and/or the visitor location registry (VLR) whether or not a mobile phone requires AoCC. The system relies on the charging logic to perform the AoCC, that is to alter the credit register each time it receives an AoC signal from the MSC. The charging logic is also required to carry out instructions to recharge the credit register. In a basic Local Storage system with AoCC the only control over the call is that of the charging logic. Hence, such a system is more exposed to fraud than Remote Storage systems. Basically, the network relies solely on the mobile phone not to let the user make calls if there is insufficient credit because once the user makes a call, the MSC will route any call request irrespective of the state of the mobile phone's credit. Thus, if the charging logic or the credit register is interfered with, the network may not be able to detect the fraud. In the most basic implementation of an AoCC based Local Storage system, the network may not even have any knowledge of the credit balance of each user's phone.

As a result, there have been some evolvements of the Local Storage pre-paid model in order to manage the risk of fraud. This involves the addition of a credit monitoring module located within the network which collects all call records related to pre-paid mobile phones and to consolidate the usage of each phone with the credit that has been registered for each phone. However, it is in the very nature of Local Storage systems, that there is no real-time control by the network over calls made by a pre-paid mobile phone. Nevertheless, some efforts have been made to introduce some level of supervision by the network. In effect this constitutes a hybrid system of Local Storage and Remote Storage systems. One such hybrid system works in principle like other Local Storage systems but also collects all call records provided by the MSC at fixed time intervals and calculates the current balance for the mobile phone based on these call records. If the balance goes below zero an alarm is generated and a message is sent to the MSC to cut off any call which is currently in progress. Furthermore, the HLR may be instructed to bar the mobile phone for outgoing calls until further notice, that is to say until credit has been re-established. Obviously, there is still exposure to fraud with the level of exposure depending on how often the call records from the MSC can be collected in order to recalculate the account balance. The balance known to the network will always lag behind the true balance.

In principle AoCC based Local Storage pre-paid systems can support seamless roaming. When an AoCC based pre-paid mobile phone signs on in a visited network, the MSC in the home network will provide information about its charging regime to the MSC in the visited network and the HLR in the home network will inform the VLR in the visited network that the mobile phone requires AoCC. The visited network may then add a mark-up to the charging information to cover their own charges. When the mobile phone is making or receiving calls, the MSC will provide the appropriate CAI signal and upon each AoC signal sent to the mobile phone the charging logic in the mobile phone will deduct the charges from the mobile phone's credit register accordingly. Once the credit is exhausted the mobile phone's charging logic will not allow any further chargeable calls to be made or received.

However, due to the high risk of fraud associated with Local Storage pre-paid systems home networks using this technology are generally reluctant to allow roaming for their pre-paid customers as the home network is liable to pay for the charges incurred in any visited network. In the face of this risk, home networks do not want to rely solely on the mobile phone's logic to control calls. In order to manage the risk some form of network supervision is required. Hybrid systems where the network monitors the charges incurred by the mobile phone in addition to the AoCC provide a means for supervising a phone. However, the monitoring of charges cannot normally take place in the home network while the mobile phone is roaming, because the call records are generated by the MSC in the visited network rather than by the MSC in the home network. Thus the home network would have to negotiate with a visited network to carry out supervision on its behalf and rely on the visited network to perform the supervision competently while still being liable for any charges incurred even in the event that the supervision of the visited network was insufficient. Such a system fails to provide the home network with any control over managing the risk. Further, the cost of implementing such a supervision regime might significantly increase roaming charges thus affecting the economic viability of the service.

Therefore, in order to ensure that a roaming user's charges are covered by the user's pre-paid account, the home network must find another call supervision technique. As with roaming for Remote Storage based pre-paid services, the most commonly used approach is a call-back system. The home network is already in control of all inbound calls forwarded to the mobile phone, because those calls are made to a phone number within the number space of the home network and therefore all inbound calls will be routed through the home network. Thus, by configuring the visited network to route any outbound call by a pre-paid mobile phone to the phone's home network from where the call is then routed to the call destination, the home network is given control of the mobile phone's calls. This allows the home network to monitor the charges incurred by the phone and also empowers the home network to terminate any call immediately when the user's credit is exhausted. While this solution is transparent to the user and meets the home network's requirement for fraud control, it is expensive as all calls have to be routed via the home network, adding further cost to those calls.

Accordingly, it would be advantageous to provide an alternative method and apparatus for allowing a mobile station to operate in a visited network.

### SUMMARY OF THE INVENTION

Therefore according to one broad aspect of the present invention there is provided a method of permitting a mobile station from a home network to operate in a visited network, said method including:

monitoring an attempt by said mobile station to sign on to said visited network to determine whether a predetermined condition is met; and

automatically initiating the creation of an account for said mobile station in said visited network if said predetermined condition is met.

Preferably, said visited network is one of a plurality of visited networks serving a geographic area, and said method involves checking that said mobile station does not have an active account in another visited network within the same geographic area before initiating the creation of an account.

In one embodiment said predetermined condition is that said mobile station is not permitted to operate in said visited network.

Preferably, said mobile station is not permitted to operate if it is not entitled to roam in said visited network.

Alternatively, said mobile station is not permitted to operate if it is not entitled to make outgoing calls in said visited network.

In still a further alternative, said mobile station is not permitted to operate if it is not permitted to incur charges on behalf of the home network in the visited network.

Preferably, said method involves requesting insertion of an entry for said mobile station in a visitor location registry.

Preferably, said method involves allocating a local phone number to said mobile station.

Preferably, said method includes maintaining said account if arrangements are made to settle charges incurred by the mobile station in the visited network.

Preferably, said arrangements involve purchasing call credits in the visited network.

Alternatively, said arrangements involve transferring call credits from the home network.

Alternatively, said arrangements involve a sponsor settling said charges.

Preferably, a user of said mobile station must listen to an advertisement on behalf of said sponsor before incurring a charge to be settled by said sponsor.

Preferably, said account is maintained while expiry conditions are not met.

Preferably, said account is closed when said mobile station returns to sign on in said home network.

Alternatively, said account is closed when said mobile station signs on in a subsequently visited network.

Alternatively, said account is closed when the user of said mobile station makes a request to close said account.

Preferably, closure of said account involves transferring remaining call credits to said home network.

Alternatively, closure of said account involves transferring remaining call credits to said subsequently visited network.

Alternatively, closure of said account involves reimbursement of remaining call credits to the user of said mobile station.

In one embodiment, said arrangements must be made within a time limit.

In one embodiment, the method involves providing a credit register for use in said visited network, and creating an account involves activating said credit register so that it can be used in said visited network.

In a further embodiment, activating said credit register may involve reconfiguring a credit register normally for use in the mobile station's home network for use in the visited network.

Alternatively, creating an account includes allocating credit and said arrangements must be made before the allocated credit is consumed.

Preferably, said method includes sending a message to said mobile station after creating said temporary account, said message including information as to how to make said arrangements.

Preferably, said determining step is carried out only when said mobile station is first turned on in said visited network.

Preferably, creating an account involves creating an account with a pre-paid service.

Preferably, the monitoring step involves intercepting communications between the visited network and the home network.

Preferably, the intercepting step involves intercepting communications between a visitor location registry (VLR) handling the sign-on attempt in the visited network and the mobile station's home location registry (HLR).

Preferably, said method involves emulating the HLR to the VLR as necessary.

Preferably, said method involves emulating the VLR to the HLR as necessary.

In another embodiment said condition is that said mobile station is pre-registered for initiation of creation of an account in said visited network.

Preferably, the monitoring step includes checking a profile associated with said mobile station and determining from said profile whether creation of an account should be initiated for said mobile station.

In one embodiment, the monitoring step includes checking a profile associated with said mobile station to determine whether creation of an account in the visited network should be offered to a user of said mobile station, offering the connection to said user, and determining from a response to said offer whether an account should be created.

Preferably, said profile is maintained by said home network.

Alternatively, said profile is maintained by said visited network.

Alternatively, said profile is maintained by a database independent of said home network and said visited network.

In one embodiment, said checking step involves checking a plurality of profiles.

In one embodiment, said method involves determining whether any of the above conditions are met.

Preferably, said method involves checking that said mobile phone does not have an active account with any other visited network irrespective of the location of the visited network, and advising said any other visited network that said mobile station is attempting to sign on in said visited network whereby said any other visited network can close said active account if appropriate.

There is also provided apparatus for permitting a mobile station from a home network to operate in a visited network, said apparatus including:

monitoring means for monitoring an attempt by said mobile station to sign on to said visited network to determine whether a predetermined condition is met; and

account creation means for automatically initiating the creation of an account for said mobile phone in said visited network if said predetermined condition is met.

In one embodiment said predetermined condition is that said mobile station is not permitted to operate in said visited network.

Preferably, said mobile station is not permitted to operate if it is not entitled to roam in said visited network.

Alternatively, said mobile station is not permitted to operate if it is not entitled to make outgoing calls in said visited network.

In still a further alternative, said mobile station is not permitted to operate if it is not permitted to incur charges on behalf of the home network in the visited network.

Preferably, said visited network is one of a plurality of visited networks serving a geographic area, and said apparatus further includes account checking means for checking that said mobile station does not have an active account in another visited network within the same geographic area before said account creation means initiates the creation of an account.

Preferably, said account checking means checks that said mobile phone does not have an active account with any other visited network irrespective of the location of the visited network, and wherein said account checking means advises said any other visited network that said mobile phone is attempting to sign on in said visited network whereby said any other visited network can close said active account if appropriate.

Preferably, said account creation means requests insertion of an entry for said mobile station in a visitor location registry.

Preferably, said method involves allocating a local phone number to said mobile station.

Preferably, said apparatus includes account maintenance means for maintaining said account if arrangements are made to settle charges incurred by the mobile station in the visited network.

Preferably, said arrangements involve purchasing call credits in the visited network.

Alternatively, said arrangements involve transferring call credits from the home network.

Alternatively, said arrangements involve a sponsor settling said charges.

Preferably, a user of said mobile station must listen to an advertisement on behalf of said sponsor before incurring a charge to be settled by said sponsor.

Preferably, said account is maintained while expiry conditions are not met.

In one embodiment, said arrangements must be made within a time limit.

Preferably, said apparatus further includes account closure means for triggering closure of said account.

Preferably, said account closure means is triggered when said mobile station returns to sign on in said home network.

Alternatively, said account closure means is triggered when said mobile station signs on in a subsequently visited network.

Alternatively, said account closure means is triggered when the user of said mobile station makes a request to close said account.

In a preferred embodiment, said monitoring means is located between the visited network.

Preferably, the monitoring means intercepts communications between the visited network and the home network.

More preferably, the monitoring means intercepts communications between a visitor location registry (VLR) handling the sign-on attempt in the visited network and the mobile station's home location registry (HLR).

Preferably, the monitoring means is provided by an extended location registry (XLR).

In this embodiment, the XLR is preferably configured so as to be transparent to the visited and home networks.

Preferably, said XLR is configured to emulate the home location registry of said home network to said visited network as necessary.

Preferably, said XLR is also configured to emulate the visitor location registry of said visited network to said home network as necessary.

Preferably, said XLR is in communication with a local charging platform and initiates the creation of an account by sending an account creation signal to said local charging platform.

Thus, it will be appreciated that account creation means are provided by the XLR and the local charging platform. It is preferred that the local charging platform is a pre-paid platform.

In one embodiment, said mobile station includes a credit register, and said account creation means is capable activating said credit register.

Preferably, said credit register is located on said mobile station's SIM card.

In a further embodiment, said account creation means activates said credit register by reconfiguring a credit register normally for use in said mobile station's home network for use in the visited network.

Preferably, said apparatus also includes a user preferences database (UPDB) which maintains profiles for mobile station users, whereby said apparatus can query said user preferences database to determine whether a mobile station attempting to sign on in the home network is registered with the user preferences database, and whether said mobile station's profile indicates that a local account should be created.

Preferably, said XLR also controls the activation of a call forwarding service in said mobile station's home network so that calls made to the mobile phone in said home network are forwarded to said mobile station in said visited network.

Preferably, said XLR also controls the activation of a unified messaging service (UMS) in said mobile station's home network so that messages left for the mobile phone in said home network are forwarded to said mobile station in said visited network.

There is also provided apparatus in said home network to send a notification signal to said XLR to notify said XLR that said mobile station has returned to sign on in said home network.

Preferably, said apparatus also sends said notification signal to said XLR if said mobile phone is known to have signed on in a subsequently visited network when said visited network does not deploy any apparatus of the present invention.

In a preferred embodiment, the above technique allows a mobile phone user who is not permitted to roam by their home network to make calls in a visited network. The user need not arrange to roam before they leave their home network and need not provide credit details. When in a visited network the user turns on their phone and if roaming is denied by their home network a temporary account is set up according to the technique of the present invention to provide sufficient opportunity for the user to make arrangements for charges incurred in the visited network to be settled.

The account need only be activated for long enough to provide the user with sufficient opportunity to buy a pre-paid voucher. It is also possible that a user could transfer credits between a home network and the visited network, provided the networks cooperate to allow such a transfer. This procedure is very convenient for the user becaus all the steps needed to allow their phone to operate in the visited network can be carried out where they are. It may not be possible for a user to arrange with their home network to enable a roaming facility once they have left the country. For example, they may be required to sign an authority in person to incur such charges.

A further advantage to the user is that they should be able to incur costs at the rate charged by the visited network and thus not incur the premium charges charged by home networks in relation to such call charges. The cost to a visited network that provides services by way of utilising the features of the apparatus embodying the new technique is minimal because they need only incur charges at cost. For example, outside of capital costs the only cost may be the cost of sending a short text message to each mobile phone which attempts to operate in the visited network; the cost of which is negligible to a network operator. Further, as it can be assumed that most persons who turn a mobile phone on in a network would like to be able to make or receive calls in that network, there is a good likelihood that persons who turn their phones on will take the necessary steps to maintain their temporary account, thus, allowing the network operator to redeem their costs.

In one alternative embodiment the above technique allows a pre-paid customer in a home network to have credit such as their pre-paid credits transferred from a home network to a pre-paid platform in a visited network so that charges can be deducted in the conventional manner employed in pre-paid services—i.e. in real time. This technique requires there to be cooperation between a pre-paid platform in the home network and a pre-paid platform in the visited network to allow credit to be transferred to the pre-paid platform in the visited network. Thus, this technique is different to existing roaming techniques in that rather than charges being incurred in a visited network and charged to the home network before being passed onto the mobile phone user, the charges are incurred and charged in the visited network in real time. This avoids the problem associated with the delay between charges being incurred in the visited network and charges being invoiced in the home network.

### BRIEF DESCRIPTION OF THE DRAWINGS

Examples of preferred embodiments of the invention will now be described with reference to the accompanying drawings in which:

FIG. 1 is a schematic diagram of the apparatus of a first preferred embodiment;

FIG. 2 is a schematic diagram of the apparatus of a second preferred embodiment;

FIG. 3 is a flow diagram showing how an account is created in the first preferred embodiment;

FIG. 4 is a flow diagram showing how a temporary account is created and maintained in the first preferred embodiment;

FIG. 5 is a flow diagram showing how an opt-in system operates;

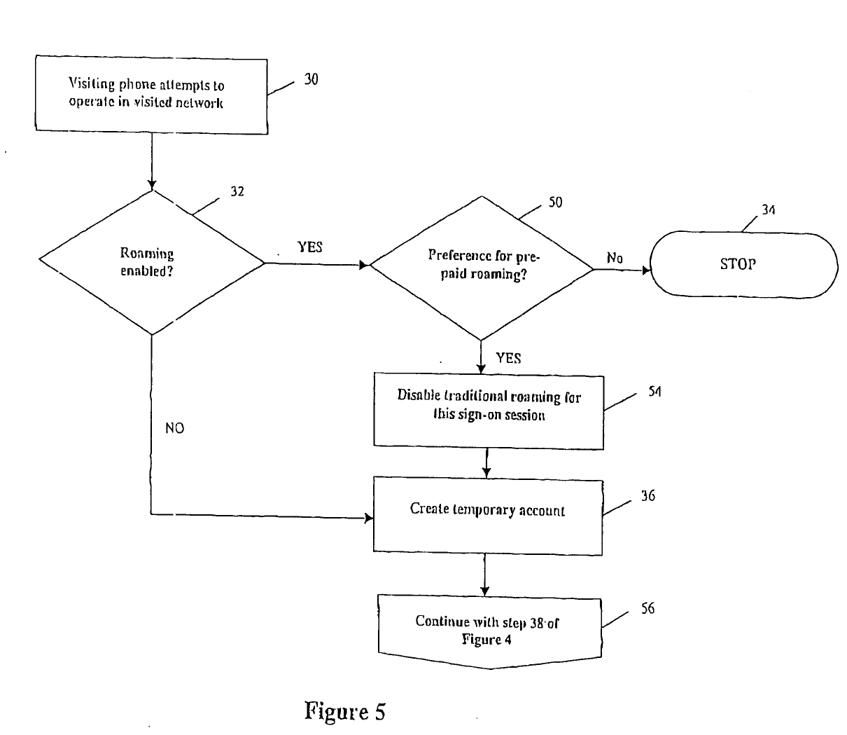

FIG. 6 is a schematic diagram of an XLR of the first preferred embodiment; and

FIG. 7 is a schematic diagram of the apparatus of a third preferred embodiment.

### DESCRIPTION OF THE PREFERRED EMBODIMENTS

The apparatus of each of the preferred embodiments provides a roaming facility in lieu of a missing roaming facility or it alters an existing roaming facility to enable mobile stations (MS) to roam in different circumstances or in a different manner.

The apparatus of each of the preferred embodiments performs a detector function and a registry function.

The purpose of detector function is to detect various events related to visitors trying to sign on and served visitors already signed on in a visited network. In particular, the detector function monitors initial sign-on to determine whether an account should be created. Thus, it will be appreciated that any detector provides a monitoring means for monitoring to determine whether an account should be created.

The registry function is to maintain data about visitors signed on in a visited network who are being served by virtue of the apparatus' operation.

The detector function can be either active or passive. An active detector function intercepts signalling, while a passive detector function solely listens on the signalling channel.

Interception means any activity that alters or diverts a detected signal. Listening means any activity that analyses a detected signal without altering or diverting it.

A local account is created provided a predetermined condition is met. The predetermined conditions vary depending on the embodiment.

The predetermined conditions fall into the following categories:

(a) Roaming is not allowed—i.e. roaming is barred (this is called a RNA condition);

(b) A restricted roaming facility is provided—e.g. the user can't make outgoing calls (this is called a RRF condition; and

(c) The user's preference for the creation of a local account is registered in a user preferences database (this is called a UPR condition).

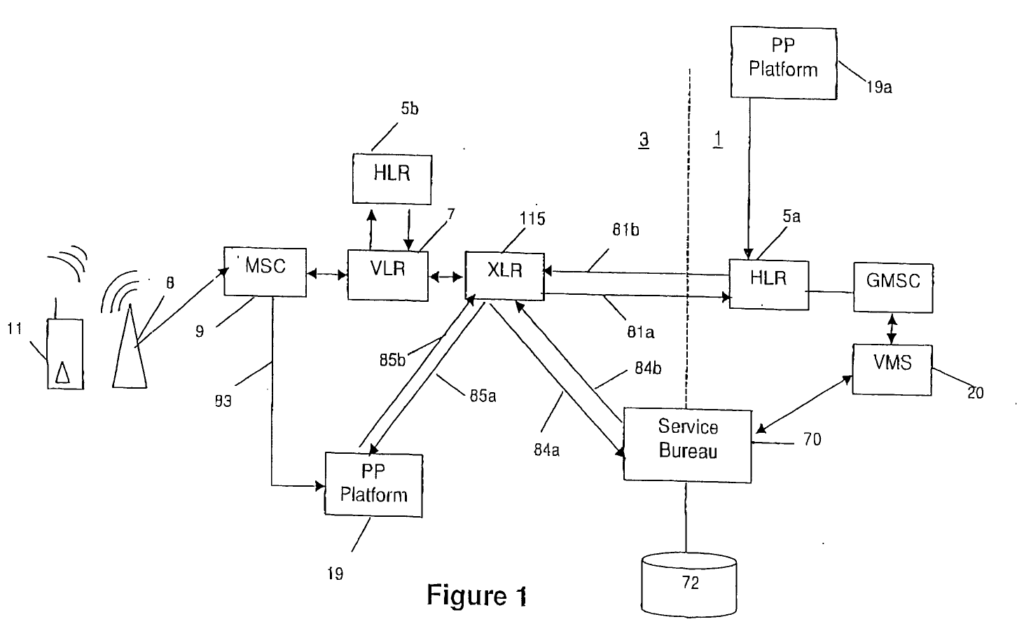

FIG. 1 shows how a mobile station (MS) 11 signs on to a visited network 3 in accordance with a first preferred embodiment of the present invention.

A mobile station's profile is maintained in a real-time database in the mobile station's 11 home network 1. This database is called the Home Location Registry (HLR) 5.

The HLR 5 continually keeps track of the mobile station's location and also controls what functions the mobile station can access. Information maintained in the HLR 5 includes service parameters such as whether the mobile station 11 is allowed to roam in visited networks and incur charges on behalf of the home network. To keep track of the mobile station's location, the HLR 5 relies on the visitor location registries of the network to advise it of the mobile station's location. Depending on the network architecture, there will be a number of VLRs 7 located throughout the network, each of which may be responsible for a number of MSCs 9. Usually, however, there is a co-location of an MSC 9 with a VLR 7. Therefore, a location update signal will usually be transmitted to the HLR 5 irrespective of whether the mobile station 11 is still within an area controlled by the same VLR 7 provided the mobile station 11 moves to an area served by a different MSC 9.

When a mobile station 11 is located in a visited network 3, and attempts to register (i.e. sign-on) in the network 3 for a first time, the mobile station's 11 attempt to register is relayed via a cellular base station 8 to the mobile switching centre (MSC) 9. The MSC 9 then checks whether the mobile station 11 is registered with the VLR 7 which has responsibility for the particular MSC 9. As the MS 11 has not previously signed on in the visited network, it will not be registered in the VLR 7. The VLR 7 will then analyse the mobile station's international mobile subscriber identity (IMSI) to determine to which network the MS 11 belongs. The VLR will then communicate with the HLR 5a of the mobile station's home network 1 to determine whether the MS 11 is entitled to roam in the visited network 3 and whether the MS should be added to the VLR 7. In a traditional roaming set-up this is determinative of whether the mobile station 11 is able to roam in the visited network 3. If the home network's records maintained by HLR 5a disallow roaming for MS 11, without the technique of the preferred embodiments, the HLR 5a will inform the VLR 7 that roaming is barred for MS 11, the VLR 7 will advise the MSC 9 that the attempt to register failed and the MSC 9 will refuse the sign-on attempt.

In the preferred embodiments additional apparatus is provided which allows the mobile station 11 to operate in the visited network 3 even if the HLR 5a indicates that the mobile station 11 is not allowed to roam in the visited network 3. Embodiments of the present invention range from active listening (or interception) to passive listening (or eavesdropping) embodiments.

The choice of an active or passive device for detecting mobile stations for which an account should be created affects how the invention is implemented. An active detection device acts to intercept all signals between the home and visited networks, and requires the least interference with the current network architecture because it emulates other network components. That is, a single “box” can be dropped into the network or in between interconnected networks and it is not necessary to alter the manner in which other network components operate. If the signal which indicates that the mobile station is not allowed to roam is not intercepted, the mobile station will be denied service after the VLR in the visited network receives the signal. Thus, a completely passive system is unable to intercept signalling between the home network and the mobile station, and is therefore unable to modify the response to the mobile station and to insert an entry in the visited network's visitor location registry. Such a passive system can only provide service to visitors with an existing roaming facility by enhancing or altering the roaming facility. It cannot provide service to visitors without any roaming facility. In contrast, an active system is able to intercept signalling between home and visited network, and is therefore able to insert an entry in the visited network's visitor location registry and to perform home location registry functionality in the absence of a roaming facility provided by the home network. Thus, an active system can provide service to any visitor irrespective of whether they have an existing roaming facility.

The first embodiment of the present invention illustrated in FIG. 1 has an active listening device positioned between the visited network and any home networks. This device is provided in the form of an XLR 115. The XLR 115 is designed to intercept all relevant signals between the visited and any home networks, to monitor sign-on attempts of mobile stations 11 to determine whether a predetermined condition such as the mobile station not being entitled to roam, is met, and to trigger creation of an account for the mobile station 11 in the visited network. Creation of an account will involve the issuance of a local telephone number for the mobile station which can be called from anywhere, ensuring that the MS is recognised within the visited network, and ensuring that the temporary account associated with the MS in the visited network 3 can be charged within the visited network 3.

Referring to FIG. 1, it will be apparent to persons skilled in the art that an XLR 115 has been placed between the VLR 7 and the HLR 5a to enable it to carry out the functions of monitoring roaming mobile stations 11 signing on in a visited network 3 to see if a condition is met (such as the MS 11 is not entitled to operate in the visited network 3) and to cause an account to be created in the visited network if the condition is met.

Referring to FIG. 1, when mobile station 11 attempts to sign on in visited network 3 for the first time, this request is passed via base station 8 to MSC 9. MSC 9 checks VLR 7 to determine whether the mobile station 11 is already registered with the VLR 7 as a roaming MS in the visited network. If the mobile station 11 is not registered with the VLR 7, the VLR 7 analyses the mobile phone's international mobile subscriber identification (IMSI) and initiates a home network look up request. In this embodiment this request is intercepted by the XLR 115 which takes over the look up request.

In a conventional network structure, the response to the home network look up request is definitive of whether the mobile station 11 is entitled to operate in the visited network 3. By placing the XLR 115 between the VLR and the home network, the XLR 115 is capable of processing the regular home network look up request, determining whether the conditions for creating a local account in the visited network are met and returning a signal to the visited network 3 which indicates that the mobile station 11 is entitled to operate in the visited network irrespective of whether an account is to be created, has been created or the MS will be a conventionally roaming MS. In this way, the XLR 115 is effectively transparent to the VLR 7 and the HLR 5a.

In this embodiment, local accounts are created with a pre-paid service either where the home network's HLR 5a indicates that the mobile station is not entitled to operate in the visited network or where the mobile station is entitled to operate but the user of the mobile station is registered with the user preferences database (UPDB) 70 as wanting a pre-paid service to be set up in any or particular circumstances (e.g. signing on in the particular visited network 3). Determining entitlement to operate may include determining whether the mobile station 11 is entitled to make outgoing calls.

The XLR 115 determines from the response to queries 81a and 84a to the HLR 5a of the home network 1 and the UPDB 70, whether a temporary account should be created for mobile station 11. If the XLR 115 determines that a temporary account should be created, it triggers the creation of the account.

Initially, the XLR 115 monitors the response 81b to the home network look up request to determine whether the mobile station has a valid subscription and whether or not it has a roaming facility enabled.

If the response 81b to the home network look up request indicates that the mobile station 11 is entitled to roam, the XLR 115 also initiates a UPDB 70 look up request 84a to determine whether the MS 11 is registered with the UPDB 70. The UPDB 70 keeps records of persons who registered their wish to have a temporary pre-paid account created in any or certain circumstances. The records contain a profile of when the owner of a mobile station wishes to have a local account. If the present circumstances are covered by the profile, following the UPDB look-up request, the XLR 115 triggers by means of signal 85, the creation of a local account.

Further, the HLR 5a may support a restricted roaming facility (for example, it may allow the mobile station 11 to receive incoming calls but not to make outgoing calls). In the preferred embodiment the XLR 115 can also trigger creation of a temporary account if the mobile station's roaming facility is restricted.

If the XLR 115 determines that the mobile station is not entitled to operate either because roaming is barred or restricted, the XLR 115 triggers the creation of a local account.

If the mobile station 11 is entitled to roam and there is no need for a pre-paid account to be created, the HLR authorises MS 11 and the roaming authorisation signal is routed back to the VLR 7 by the XLR 115.

It will be appreciated that the role of the XLR 115 is to simulate the HLR 5 to the VLR 7 and to simulate the VLR 7 to the HLR 5 so that the existence of the XLR 115 is not apparent to either of the other network elements. As a result, there is no need to modify the structure of either of these components.

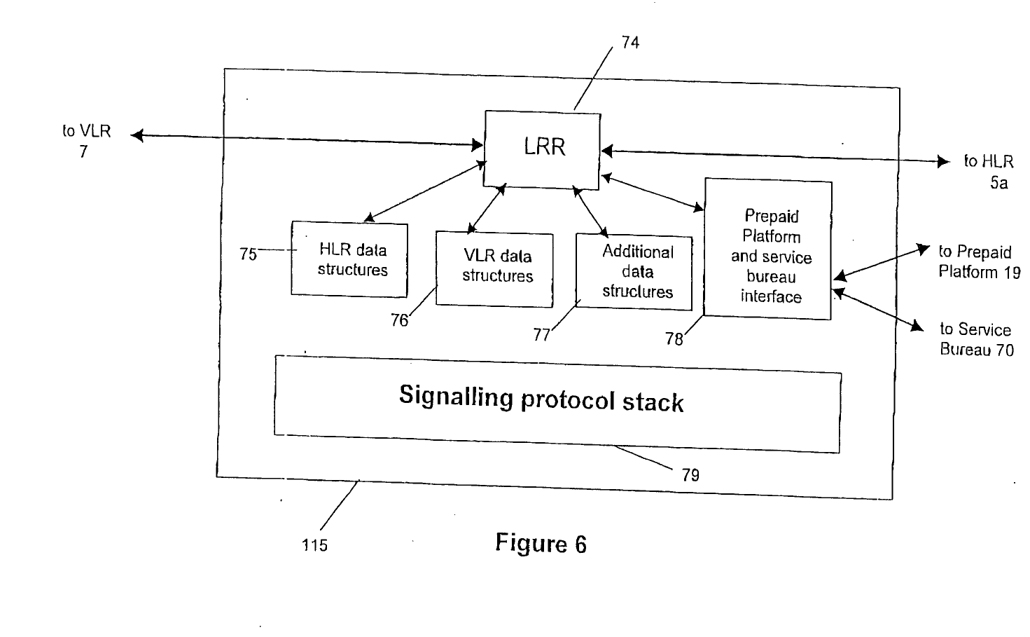

FIG. 6 is a schematic representation of the various functions carried out by the XLR 115. The HLR data structure 75 includes those data structures which are necessary to simulate the HLR function to the VLR 7. For example, where a pre-paid account has been created as will be described in further details below, to allow the MS to operate it is necessary for the XLR 115 to be able to imitate the HLR 5a to the VLR 7 each time the VLR 7 attempts to update the location of the mobile station 11 with the HLR. Further, if an alternative VLR attempts to authenticate the MS 11, the XLR 115 intercepts the signal and provides an appropriate response to the HLR. Similarly, the VLR data structures 76 enable the XLR 115 to simulate the VLR 7 to the HLR 5a and also to buffer any further requests from the VLR 7 while the XLR 115 is dealing with HLR 5a. Signalling protocol stack 79 allows the XLR 115 to carry out the appropriate signalling. Any appropriate signalling protocol may be used.

To this end as illustrated in FIG. 6, the XLR 115 includes a look-up request router (LRR) 74 which deals with both the VLR 7 and the HLR 5 and is capable of accessing and/or communicating with a number of other components in order to: support the necessary emulation of the HLR 5 and the VLR 7; to host the necessary information in order to support the continuing function of the mobile station 11; and to communicate with the pre-paid platform 19 and the user preferences database UPDB 70.

The additional data structures 77 relate to the user preferences database UPDB 70 and pre-paid platform 19, and include profiles for each user including a temporary number (MSVTLN). The UPDB and pre-paid platform interface 78 allows the XLR to communicate with the UPDB 70 and the pre-paid platform 19 to carry out and assist the creation and maintenance of temporary pre-paid accounts.

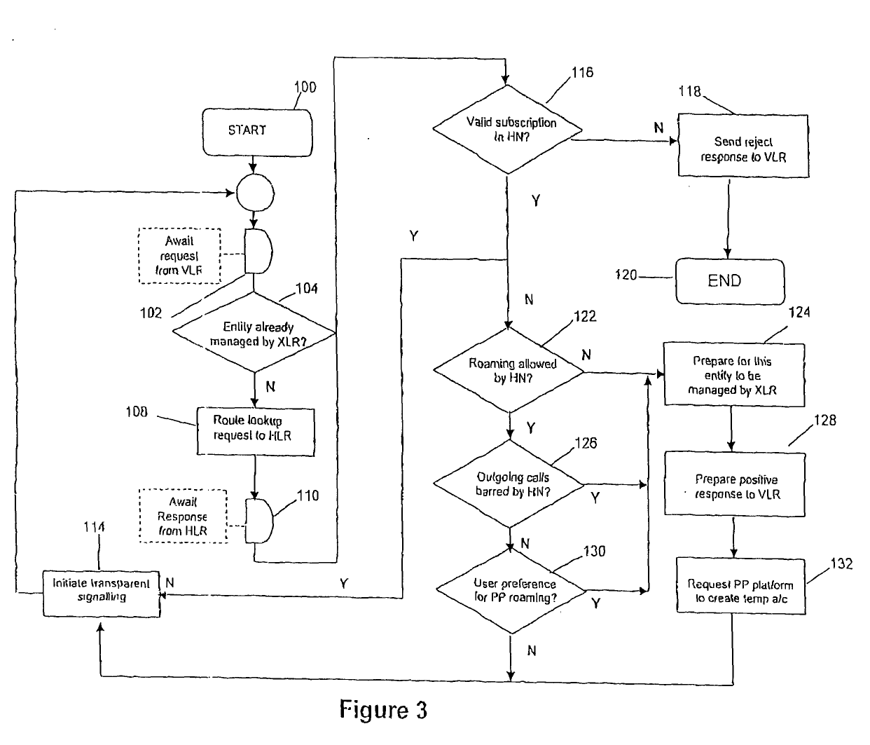

The preferred embodiment will now be described further with reference to the flow diagram of FIG. 3 which describes the function of the XLR 115. Once the XLR 115 is initiated at step 100, it awaits requests from the VLR 7 at step 102. When it receives a request it determines at step 104 whether the mobile station is already managed by the XLR 115. If it is already managed, the XLR 115 simulates HLR 5a functionality to the VLR 7. If it is not managed by the XLR 115 it routes a look up request to the HLR 5a at step 108. At step 110 it awaits response from the HLR 5a. If the request/response is not sign-on related—ie. does not relate to initial sign-on in the network, at step 114 the response is routed to the VLR 7. If it is sign-on related, the XLR 115 first determines whether there is a valid subscription in the home network at step 116 and if there is not, at step 118 a reject response is sent to the VLR 7 and the process ends at step 120. If the MS 11 has a valid subscription, the XLR 115 proceeds to step 122 and determines whether roaming is allowed by the home network 1. If roaming is not allowed the XLR 115 prepares for the mobile station to be managed by the XLR 115, then at step 128 prepares a positive response to the VLR 7 and at step 132 it requests the pre-paid platform 19 to create a local account.

If roaming is allowed by the home network, the XLR 115 proceeds to step 126 and determines whether there are restrictions imposed on the mobile station 11 operating in the visited network, for example, outgoing calls from the visited network are barred by the home network. Thus, if the MS 11 is not fully entitled to operate in the visited network, steps 124, 128 and 132 are repeated.

If there are no restrictions, at step 130, the XLR 115 checks the user preferences database UPDB 70 to determine whether the user's profile stored in the UPDB 70 indicates that a pre-paid roaming account should be created and, if it does, follows steps 124, 128 and 132. The circumstances in which a user preferences database look up will be invoked will be discussed in further detail below.

The function of the XLR 115 will now be described in more detail. When a mobile station 11 is powered on or moves into a new service area it will issue a look up request to the local MSC 9 and the MSC 9 will initiate a location update procedure. This procedure is started by sending an update location area signal to the VLR 7. If the VLR 7 has a valid record for the mobile station i.e. there is a record entry for this mobile station's IMSI or TMSI and the MS was previously in a location area controlled by this VLR 7 there is no need to update the HLR as to the mobile station's new location.

If there is no record of the mobile phone in the VLR 7, then the HLR 5a must be updated as to the mobile station's current location so that the mobile station is locatable on a macro network level and so that the VLR 7 is provided with up to date profile information regarding the mobile station's identity and capability. The procedure for updating the HLR 5a is carried out with the signal pair: Location Update/Acknowledge.

In the preferred embodiment, the location update procedure can be separated into two different cases:

a) Initial registration for the purpose of location updating when the mobile station is unknown to the visited network, in this case the XLR 115 acts as the HLR 5a towards the visited VLR 7 and as the visited VLR 7 towards the HLR 5a;

b) Subsequent registration, during further location updating where the mobile station is known to the XLR, in which case the XLR 115 will act as the HLR 5a towards the VLR 7 within the visited network.

Prior to the VLR 7 initiating a location update towards the HLR 5a, the VLR 7 may request authentication of the mobile station 11. The authentication procedure may be a request to the HLR 5a to supply authentication information for this mobile station 11. This procedure is undertaken by a signal pair: Send Authentication Info/Send Authentication Info Acknowledge.

During initial registration, if the authentication request is received as part of the mobile station's initial registration then no knowledge of this subscriber will exist within the XLR 115. In this case the XLR will pass the authentication request transparently to the mobile station's home HLR 5a. When the response is received the XLR 115 will act as follows:

a) If the response contains authentication sets, the XLR will store the authentication sets in the HLR data structures 75 against the mobile station's IMSI and update its records for the mobile station to indicate that authentication is complete. If the response is positive but empty then the XLR 115 will mark the mobile station's entry to indicate that authentication is empty.

b) If an error is received and the error is that the MS is an unknown subscriber then the XLR 115 will mark the mobile station's record to note that it is an unknown subscriber. Any other error will also be recorded. The authentication response information will then be sent to the VLR.

c) If an authentication request is received as part of a mobile station's subsequent registration then the XLR 115 will pass the authentication request transparently to the HLR.

Following authentication of a mobile station 11, when an initial update location request is received for the mobile station 11, the XLR 115 will pass the update location request to the mobile station's HLR 5a for processing. When the response is received from the HLR 5a, the XLR 115 will analyse to check whether or not a temporary account should be created. For example, if the mobile station is not registered with the user preferences database UPDBD 70 or if a UPDB 70 is not implemented, and the mobile station is not barred from roaming within the visited network 3, the XLR 115 will create an entry for this MS 11 which indicates that its home network allows roaming. Once this entry has been created, the XLR 115 merely needs to check the mobile station's status and pass any requests from the VLR to the HLR 5a transparently.

If roaming is barred or restricted, the XLR 115 will create a record for the mobile station and set its state to roaming barred and then request the creation of a new account from the pre-paid platform. If the pre-paid platform successfully creates a new account then it will return a mobile station visitor's temporary local number (MSVTLN) unique to the mobile station 11 and this will be stored in the record for the MS 11. The MSVTLN is diallable while the MS 11 remains in visited network 3. The XLR 115 will then build one or more insert subscriber data messages and send them to the VLR 7. During all of these stages, appropriate acknowledgment signals which would be expected from either the HLR 5a or the VLR 7 are generated by the XLR 115. It will be understood that the creation of an account for the mobile station 11 includes making an entry for the MS 11 in the XLR 115. The creation and maintenance of pre-paid accounts will now be described in more detail.

When the XLR 115 identifies a mobile station 11 for which an account is to be created, in the preferred embodiment, the XLR 115 advises by means of signal 85a the local charging platform in the visited network, such as a prepaid platform 19 to create a new account for the mobile station 11. The pre-paid platform creates account information for the mobile station 11 and passes this back by signal 85b to the XLR 115. This procedure is called Creation of Temporary Account (CoTA); signal 85a is called CoTA request and signal 85b is called CoTA acknowledgment. The XLR 115 then requests the VLR 7 to make an entry for this MS. The XLR stores the account information so that it is associated with the mobile station's IMSI.

In an alternative example of the preferred embodiment, the XLR 115 will first determine whether the mobile station 11 already has an active in another visited network (not illustrated). If it is, the XLR will then determine whether the other visited network serves the same geographic area. If the MS has an account active with another network within the same geographic area, then depending on user preferences registered in UPDB 70 the XLR 115 may not initiate the creation of a new account for MS 11 in visited network 3. This would force the MS eventually to sign on in the visited network where the MS has an active account and ensure that two accounts aren't created for the same geographic area If the user preferences in UPDB 70 indicate that an account should be created with the new visited network, the XLR 115 will trigger the closure of the account in the previously visited network to be closed by sending an account closure request to that network as well as initiating the creation of an account. If the XLR 115 determines that the MS 11 still has an active account with a previously visited network (not illustrated) in a different geographic area, then independent of the user preferences in UPDB 70, the XLR will also trigger the closure of the account in the same manner. This procedure ensures that a mobile station will not accidentally have more than one active account at the same time.

In the preferred embodiment, when the account is created the XLR 115 sends a message to the mobile station 11 advising the user of the MS 11 how to make arrangements to maintain the temporary account by purchasing call credits in the visited network 3 or otherwise arranging to settle charges in the visited network 3. The XLR 115 also advises the user what local telephone number MSVTLN has been assigned to their MS. At this stage steps are also undertaken to allow a person calling the user on the telephone number in the home network to be either connected directly to the mobile station 11 or advised how to contact the MS 11. These steps are discussed in detail further below.

The local charging platform in the visited network monitors the local account for the mobile station to determine whether the expiry conditions for that account have been met and hence whether the account should be maintained. The expiry conditions will vary depending on the method for settling charges and also the history of usage of that account. For example, if an account is created and a user makes no effort to purchase further call credits within a fixed time period such as fourteen days, then there is a reasonable assumption that the user does not really want to use the account and the account is cancelled. As the visited network receives revenue for terminating incoming calls it may make the termination of a temporary account dependent on the number of incoming calls received by the MS. In this case, the user's account would not be terminated provided there is a sufficient flow of incoming calls.

While less preferred, it is possible that a billing account may be created as part of the creation of an account when a predetermined condition is met. In general there are two methods of creating a temporary billing account:

a) Automatic account creation wherein a temporary billing account is created automatically within the visited network's billing system in the same manner as a temporary prepaid account; and

b) Semi-automatic account creation wherein a temporary billing account is created within the visited network's billing system, but with some user interaction in order to complete account creation.

In order for an account to be created automatically, the user registers such details as are necessary to obtain a temporary billing account in visited networks with the user preferences database UPDB 70. Such details would typically be:

credit card information

authorisation to provide credit card details to visited networks

circumstances in which a billing account is to be applied for; or a list of networks in which a billing account is desired

preferred length of account period (minimum and maximum period)

preferred service plan (low, medium or high usage plan)

billing address (credit card billing address or alternative address)

whether an itemised invoice is required or not

maximum deposit authorised

fallback method in case account application is unsuccessful (e.g. fallback to temporary prepaid account or traditional roaming facility).

The details are then stored within the user's profile in the user preferences database 70 which is typically maintained by a service bureau entity.

When the user signs on in a visited network, the XLR 115 requests a temporary account from the visited network's billing system (not illustrated) according to the user's preferences in the user preferences database 70.

The visited network's billing system processes the application accordingly and returns a message to the XLR 115 with the result of the application. While processing the application, the desired account validity period and the authorised amount to deposit may be verified interactively with the user by sending a USSD message to the mobile station to which the user keys in a response. Otherwise the user's profile may be matched to the operator's default choices. If the account application fails, then the XLR will initiate the fallback method and proceed either with requesting a prepaid account from the prepaid platform in the visited network or it will pass the response from the home network's HLR back to the visited network's VLR without any intervention. Then, the user is notified of the failed account application by USSD or by email to an email address specified in the user preferences database 70. If the account application is successful, the user is notified of the MSVTLN, the deposit debited to the user's credit card, the service plan, the account validity period and the billing cycle. Afterwards the user is treated like a local user on a billing service plan, with the difference that charges are debited to the user's credit card at the end of each bill cycle and an itemised bill if requested is sent to the user's credit card billing address unless an alternative address is specified in the user preference database 70. The bill may also be sent by fax or by email. When the validity period ends the temporary billing account will automatically be closed and at the next bill run (latest) any remaining deposit will be returned by crediting the user's credit card.

To semi-automatically create an account, during sign-on, the user is connected to the customer service centre and an operator or an IVR system obtains all the details necessary to process a temporary billing account application. Some details may be provided by the XLR 115 from the user preferences database. The user may be required to sign a form depending on the policy of the visited network or the legislation in the visited country and the operator or IVR can advise a venue for the signing. Again, if unsuccessful the XLR 115 will initiate the fallback method. Otherwise the user will be treated as a local user as described above.

In order for the billing system in the visited network to process call records for visitors properly, it will be necessary to amend its function such that it can distinguish between ordinary visitors who use traditional roaming and visitors for whom a local billing account has been created. Call records relating to traditional roamers have to be charged to their respective home networks, while call records relating to visitors with local billing accounts have to be charged to their respective local accounts and must not be charged to their home networks.

Returning to FIG. 1, once the user's mobile station 11 has been registered in the visited network 3, the user makes outgoing calls in the same manner as they would make calls in their home network. It is preferred, but not essential that each time the MS 11 makes a call, a call connection request is relayed via a cellular base station 8 to the MSC 9 and the MSC 9 routes the call via a service node associated with the pre-paid system 19. The service node located between the MSC voice ports and the destination will take control over any traffic relating to calls initiated from mobile stations which are subscribers to the pre-paid system 19. The MSC 9 allows the MS 11 to attempt to make calls and when it routes a call to the service node with instructions to route to a destination, the service node checks whether the call is allowed or not. If it is, the service node will let the call pass through, if not, it will terminate the call and usually connect the user to a recorded message telling them why the call cannot be completed. The service node operates to maintain the appropriate account balance for the MS; this also allows for calls to be terminated instantly if the credit associated with the MS is exhausted while the call is in progress. All the MSC 9 needs to know is that anyone who is a pre-paid user will be routed to the service node for further processing. The MSC 9 tells the service node the routing instructions to connect the call. The system may also be implemented without a service node between the MSC and the destination and may use other configurations for pre-paid systems monitoring account credit and controlling calls which are known in the art.

One alternative arrangement for settling charges would be where a sponsor agrees to settle the charges on behalf of the mobile station. The sponsorship agreement to settle these charges would usually be conditional upon the user of the mobile station doing something else, for example, signing in to stay at a particular hotel. In a typical sponsorship arrangement, a user is allocated call time in exchange for listening to an advertisement. For example, when a user makes a call they may have to listen to twenty seconds of advertising before being connected to the called party whom they may be allowed to speak to for forty seconds before the call is terminated. This scenario can also be applied to incoming calls to the MS.

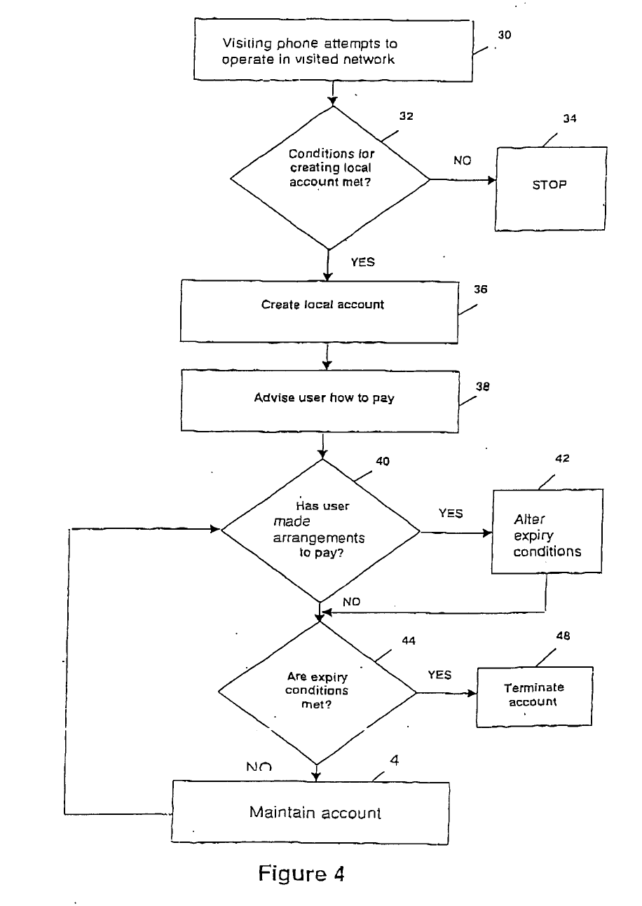

The operation of sign-on and account maintenance will now be described further in relation to the flow diagram of FIG. 4. At step 30 the visiting MS attempts to sign on in the visited network 3. At step 32 the XLR 115 determines whether a condition for creating a local account for MS 11 is met and if it is not, the apparatus takes no further action. If a condition is met, the system proceeds to step 36 and creates a local account. At step 38, a message is sent to the mobile station advising the user how to settle charges incurred in the visited network 3. The apparatus then monitors at step 40 whether the user makes arrangements to pay for costs incurred by the mobile station 11 in the visited network. If, for example, the user purchases additional call credits, the conditions of expiry are altered at step 42. The system then monitors whether expiry conditions are met at step 44.

The expiry conditions will depend on a large number of factors. These factors include the type of arrangements being made to settle call charges. For example, if the call charges are to be met by a sponsor there is little need to terminate the account. However, after a fixed time, if the user has not made any calls then an expiry condition may be triggered and the account will expire. Alternatively, if the user has purchased a number of call credits then it is advisable to keep the account open as long as possible however, under the terms and conditions of the service, call credits may have to be used within a time period. While the expiry conditions are not met the account is maintained and the account is continuously monitored at steps 40 and 44. If the expiry conditions are met the account is terminated at step 48.

As an alternative to terminating the account, the account can be suspended for a period of time and then terminated following this period to avoid the need to recreate a new account for the user if the user has merely delayed in making arrangements to settle their account.

Account termination and suspension criteria will depend on the size of the network and the pressure suspended accounts place on number availability in the visited network.

The manner in which the MS 11 is kept in contact with the home network 1 will depend on the level of technical and financial cooperation between the home and visited network and will now be described in further detail.

In a first example of the first preferred embodiment there is no cooperation between the home network 1 and the visited network 3. As the mobile station is outside of the service coverage area of the home network, a call made to the MS 11 by another phone will be typically forwarded to a voicemail service (VMS) 20. Thus, unless action is taken to alter the VMS 20, typically the caller will get the user's usual prerecorded message asking the caller to leave a message and the caller will not know how to contact the user of MS 11.

In the first example of the preferred embodiment of the present invention where there is no cooperation between the networks, the XLR is configured so that it can alter the greeting message of VMS 20 for the MS 11. When the phone is allocated a MSVTLN, the XLR 115 contacts the user preferences database UPDB 70 to obtain the user's details. The user typically provides the maintainer of the user preferences database with details in advance to allow for the user's voicemail greeting to be altered automatically. However, if when the visited network 3 contacts the UPDB to provide the MSVTLN, it is advised that the user's details have not been provided to the UPDB and the XLR 115 will then advise the user of the mobile station that they need to provide their details. Once the details have been provided, the XLR 115 alters the user's greeting message so that the messag includes an announcement of the user's temporary phone number MSVTLN. Typically, the greeting placed on the user's voicemail would be a computer generated message advising that the user can be temporarily contacted on an alternative number.

Once the user has provided sufficient details to the maintainer of the user preferences database and the details have been inserted in the UPDB, the greeting message of VMS 20 can be altered automatically without further involvement from the user whenever the user visits a new visited network. Details can be provided via an interactive voice response system (IVR) or an Internet interface (i.e. WWW/WAP) to a centralised service bureau that maintains the user preferences database. This allows a user to provide or alter details wherever they are in the world.

Further to the technique of altering the user's voicemail greeting as described above, the XLR 115 may also activate a unified messaging service (not illustrated) in the home network 1, if there is cooperation between the home network 1 and the visited network 3. In such an arrangement, when the mobile station 11 has been assigned a local voicemail box associated with the temporary account in the visited network, the XLR 115 sends a signal to apparatus in the home network to activate a unified messaging service (UMS), which will forward voice messages left for the mobile station with VMS 20 in the home network to the local voicemail box in the visited network. The home network 1 will then forward all voice messages left for the MS to the visited network 3, from where they can be retrieved without incurring the cost of an international call to the home network. Alternatively, the UMS may be configured to forward voice messages to an email address associated with the MS or specified by the user.

In a second example of the preferred embodiment, the system operates generally as described in relation to the first example preferred embodiment, however, in the second example there is cooperation between the home network 1 and the visited network 3 in relation to dealing with calls made to visiting MS 11 via the home network. In this example, when the mobile station 11 is turned on in the visited network and allocated a temporary number MSVTLN, the XLR 115 serving the visited network sends a signal to apparatus in the home network, which provides for forwarding of calls to the MSVTLN issued by the visited network. The home network 1 will then forward all incoming calls to the MS to the temporary number in the visited network 3.

Forwarded calls can be charged in two different ways depending on the level of cooperation between the visited network 3 and the home network 1. It will be understood that where a mobile station 11 has calls forwarded from one network to another it is usual for the called party to incur the costs of the forwarded calls. Therefore, in the second example embodiment the home network 1 charges the MS 11 for forwarding a call from the home network to the MSC 9 of the visited network by charging, for example, the mobile station's pre-paid account with the pre-paid system of the home network 1. It will be understood that the mobile station's account in the home network need not be with a pre-paid system but could be with a conventional billing system.

An alternative technique for charging an account associated with mobile station 11 requires more cooperation between the networks so that a settlement procedure is in place between the networks which allows a portion of the charges collected in the visited network 3 for calls forwarded by the home network 1 to be remitted to the home network 1 as a settlement between the two networks. In this example, the charge for the forwarded call from call forwarding service 27 to MSC 9 is charged to the pre-paid system 19b in the visited network 3. This example is of particular convenience because it allows all charges to be charged in the visited network 3. This allows the user of the mobile station 11 to closely monitor their level of credit. This is particularly useful for situations where the mobile station 11 has a pre-paid account in the home network as a user does not need to worry about their account balance in their home network. If the user has a pre-paid account in their home network they may quickly use all of their credit if forwarding charges are being incurred in that network. As they will be absent from the network at the time, it will be difficult for them to purchase additional credits.

In a third example of the first preferred embodiment there is close cooperation between the two pre-paid platforms in the two networks 1, 3. In the third preferred embodiment, the XLR 115 is in communication with a pre-paid platform. The XLR 115 determines whether call credits can be transferred between the two platforms. If transfer is enabled, then credit is transferred from pre-paid platform to pre-paid platform. Again, the manner in which credit is transferred depends on the level of cooperation between the systems. The user may be required to control credit transfer between the two networks. The user may have set up a predetermined rule using the service bureau that, for example, half of the user's credit is to be transferred or, in another example, that ten dollars of call credits are to be transferred at a time as necessary. Alternatively, the user may manually request the transfer of credit as necessary using a predetermined set of key strokes. The user can also purchase new credits in the visited network 3. The home network 1 would usually charge a commission on each transfer of credits in order to make up for the fact that money is essentially being transferred from their network to another network and to redeem the cost associated with the establishment and maintenance of credits. In a further example, there is extremely close cooperation between the two networks. In this example, whenever a user signs on to a new network, all of their credits are transferred from their home network or their last visited network to the new visited network and when they eventually return to their home network, remaining credits are transferred from their last visited network to their home network. Thus, at this level of cooperation it appears to the user as if they have a single portable telephone account.

The manner in which a temporary account can be closed other than by way of expiry will now be described in more detail.

In one arrangement a temporary account is closed when the user signs on in another network. When the mobile station 11 returns to sign on in the home network 1, or when the mobile station 11 signs on in a subsequently visited network to roam under a traditional roaming facility, apparatus in the home network will send a notification to the XLR 115. The XLR 115 then sends an account closure request to the visited network 3. As a result of the account closure request, prepaid platform 19 will transfer any remaining credits to the home network 1 after deducting any transfer charges and close the account. However, if the mobile station tries to sign on in a subsequently visited network under a roaming facility of the present invention, the XLR 115 will detect the sign-on attempt and send an account closure request to the previously visited network. As a result of the account closure request, the prepaid platform in the previously visited network will transfer any remaining credits to the XLR 115 after deducting any transfer charges and close the account. The XLR 115 will transfer the credits to the subsequently visited network as soon as a new account has been created for the mobile station 11.

In another arrangement a temporary account is closed when the user of said mobile station makes a request to close said account. In order to make such a request, the user may send a message to the visited network, i.e. a certain USSD message or an SMS containing a certain keyword. Alternatively, the user may call a certain number or an IVR to register a request for account closure. The next time mobile station 11 is powered off or moves out of the coverage area of the visited network 3, apparatus in the visited network 3 will send a notification of voluntary account closure to the XLR 115 and prepaid platform 19 in the previously visited network will transfer any remaining credits to the XLR 115 after deducting any transfer charges and close the account. The XLR 115 will transfer the credits to the home network 1. Alternatively the XLR 115 may wait until it receives a sign-on notification from the home network or until it detects a sign-on attempt in a subsequently visited network. In this case the XLR 115 will then transfer the credits to the respective network where the MS 11 has signed on.

Whenever the XLR 115 is notified of account termination or whenever it initiates an account closure, it will undertake appropriate steps to deactivate any call forwarding service and any unified messaging service, which may have been activated upon account creation by sending service cancellation requests to apparatus in the home network 1. It will also reset VMS 20 in the home network 1 to the default voicemail greeting for mobile station 11, if the greeting was altered upon account creation. Once the account has been closed and all associated services have been deactivated or reset, the XLR will send a message to the user via short messaging service to the mobile station's MSISDN or by email to an email address registered by the user with a notification of the account closure.

In a fourth example of the first embodiment, there is provided an alternative system which allows:

a) Users from a Home Network (HN) which has a local storage pre-paid system to roam in a Visited Network (VN) with a Local Storage based pre-paid system;

b) Users from a HN which has a Remote Storage pre-paid system to roam in a VN with a Local Storage based pre-paid system; and

c) Users from a HN which has a Local Storage pre-paid system to roam in a VN with a Remote Storage based pre-paid system. As in the first three embodiments, this alternative roaming system allows a user's mobile station to make calls in a visited network when they do not have permission to roam from their home network.

For the benefit of simplicity it is assumed that the described alternative roaming system is based on SIM card technology. However, the techniques described are equally valid and applicable to cellular phone systems and arrangements that utilise custom-built mobile phone firmware instead of SIM cards.

In an example of a SIM card based embodiment, a SIM card is provided which has a primary and a secondary credit register, the secondary credit register being for use in visited networks that provide a SIM card based pre-paid system. Herein, because the primary register is for use in the home network it is referred to as the home network credit register (HNCR). Similarly, the secondary register is for temporary use in any visited network with a SIM card based pre-paid service, and hence is referred to as the visited network credit register (VNCR). Logic is provided on the SIM card which allows it to distinguish between home credit and temporary credit and to alter the balance stored in these registers. When a mobile station visits a visited network, and attempts to register in that network, the XLR 115 monitors return signals 81b from the HLR 5a to determine whether the mobile station is allowed to roam. If the mobile station is not entitled to roam, this triggers the creation of a temporary account as described above. Unlike the previous examples of the first embodiment the VNCR needs to be activated in order to enable the mobile station to operate and this constitutes part of the creation of a temporary account for the mobile station. Once, the account has been activated, the MSC in the visited network, recognises that the mobile station belongs to the visited network's pre-paid service and it will issue CAI and AoC signals as necessary in order to notify the mobile station about applicable charges and to deduct credit from the VNCR.

As in the previous examples a number of different arrangements can be made to allow the temporary account to be maintained. In most cases, credit can be added by the user purchasing a voucher, and entering it as they would in their home network. The pre-paid platform will then send a credit notification, i.e. by way of an encrypted SMS or USSD to the mobile station to advise it to add the corresponding amount of credit to the VNCR.

However, other techniques may be used to allow the mobile station to continue to operate. For example, a limited initial credit may be allocated when activating the VNCR so that the mobile phone can be used while arrangements are being made to maintain the account.

Sponsored calls may need to be initiated by calling a special phone number which is free of charge so that the MSC generates a CAI signal with a zero charge for such calls.

Alternatively, when a sponsored call is made, the system will send a credit notification message to the mobile station once an advertisement has been listened to. The corresponding credit can then be used to proceed with the actual call.

It is also possible, where there is some cooperation between the home network and the visited network, respectively their pre-paid systems, that credit vouchers may be applied to a user's accounts in both networks. In this case, when a voucher is registered within the visited network, the user will be connected to an interactive voice response (IVR) system. The IVR will then require the user to specify whether the credit of the voucher being entered is to be applied to the home credit (i.e. the HNCR), to the visited credit (i.e. the VNCR) or to be split in some manner between the two accounts.

As in the previous examples, a number of different arrangements can be made in order to keep the mobile phone user in touch with their home network. If a forwarding service is established, where calls made to the mobile station's home network are forwarded to the phone in the visited network, such calls can be charged for in a number of different manners. In a preferred example, calls forwarded from the home network are charged to the HNCR while outgoing calls are charged to the VNCR. In this manner, there is no need for settlement between the two networks. However, in this arrangement the home network will send instructions to the mobile phone in the visited network so that it deducts credit from its HNCR. In the preferred embodiment, the SIM card's charging logic will adjust the HNCR in accordance with charging instructions contained in an encrypted SMS or USSD message sent by the home network.

A number of hybrid arrangements are used to deal with situations where there are different pre-paid architectures in the home and visited networks. For example, if the home network's pre-paid service is based on a Remote Storage system but expects users to wish to roam using pre-paid roaming in networks with SIM card based Local Storage pre-paid systems, the home network can provide the user with a SIM card that has a VNCR for use within such a visited network. A similar solution can be applied where the user's home account is billing based, and a temporary account in the visited network can be prepared incorporating the VNCR located on the SIM card.

The possible arrangements where there are different pre-paid architectures in participating networks are:

a) VN and HN usage charged by AoCC;

b) VN usage charged by AoCC and HN usage charged by an alternative method; and

c) HN usage charged by AoCC and VN usage charged by an alternative method.

In arrangement a) the VN will issue CAI and generate AoC signals both for outgoing calls and for inbound forwarded calls from the HN. However, this model restricts the ability of the visited network to charge for directly incoming calls. Upon receiving an AoC signal, the charging logic on the mobile phone will deduct charges

i) from the HNCR for all incoming calls; and

ii) from the VNCR for all outgoing calls.

Therefore, the CAI signal must set a zero charge for inbound calls made directly to the MSVTLN as otherwise they would be charged to the account in the home network, which would be incorrect. As a result the VN cannot charge the user for directly incoming calls.

In arrangement b) the VN's CAI signal will only set non-zero charges for outgoing calls. Additionally, the VN's CAI signal will also set non-zero charges for inbound calls directly to the MSVTLN but only if incoming calls are charged by the VN. For all inbound forwarded calls from the HN, the VN's CAI signal must either set a zero charge or the AoC signalling must be turned off because these calls will be charged by an alternative charging method.

In arrangement c) the VN's CAI signal will only set non-zero charges for inbound forwarded calls from the HN. For all outgoing calls the VN's CAI signal must either set a zero charge or the AoC signalling must be turned off because these calls will be charged by an alternative charging method. If incoming calls to the MSVTLN are to be charged by the VN, then such inbound calls are charged by that alternative method and must not incur an AoCC charge.

Alternative charging methods are either based on the Local Storage principle or on the Remote Storage principle. If an alternative charging method is based on the Local Storage principle, then an alternative charging signal other than AoC will be sent to the mobile station's charging logic to deduct a charge from the appropriate credit register. If an alternative charging method is based on the remote storage principle, then there is no need to apply a charge to any credit register, but instead the network applies the charge to the database where the user's credit is stored.

However, in cases where AoCC is the normal charging method and an alternative Remot Storage based charging method is only used while roaming, then it will become necessary for the HN to keep the HNCR synchronised with the credit balance as it is tracked by the network. In this case the HN's pre-paid platform will send an alternative charging signal other than AoC to the mobile station from time to time and the charging logic in the MS will update the HNCR accordingly to reflect the true credit balance. In such an arrangement the HN's pre-paid platform will ensure that the HNCR reflects the true balance when the user returns and signs on again in the home network.

An alternative charging signal other than AoC is either implemented as an encrypted SMS or USSD message. However, it will be apparent to persons skilled in the art that in future there may be other protocols built into mobile phones that can be used as a transport medium for instructions to a charging logic to alter a credit register and that any suitable transport medium may be used.

In an alternative arrangement the AoC signalling standard is modified so as to incorporate different AoC signals in order to allow the charging logic in the mobile station to apply different signals to different credit registers. This method will require one or more combinations of the following distinguishable signals to be implemented:

a) a specific CAI signal to notify the charging logic of a charge applicable to the HNCR (HNCAI); and

b) a specific AoC signal to advise the charging logic to apply a charge as per HNCAI to the HNCR, (HNC-AoC); and

c) a specific CAI signal to notify the charging logic of a charge applicable to the VNCR, (VNCAI); and

d) a specific AoC signal to advise the charging logic to apply a charge as per VNCAI to the VNCR, (VNC-AoC); and

e) a universal CAI signal to notify the charging logic of a charge applicable to the VNCR or the HNCR (UCAI), the universal CAI signal containing information identifying either the VNCR or HNCR.

In order to ensure backwards compatibility with existing AoCC signals the signals applicable to the primary register, the HNCR, are used as default signals.

Where the pre-paid service of the home network is based on a Local Storage system and the pre-paid service in the visited network is based on a Remote Storage system, a temporary account can be created without reference to the SIM card since the visited network is using a different technology to manage local credit in the manner described in relation to the Remote Storage based embodiments.

As the SIM card's charging logic will not normally allow outgoing calls to be made if the credit is below a certain level, it is necessary for the visited network to issue CAI signals with zero charges and provide AoC signals as otherwise the mobile station may not be able to operate in a visited network with a Remote Storage based pre-paid service that does not require nor expect the MS to control the call.

In a further alternative, where there is close cooperation between home network and visited network, respectively their pre-paid systems, the credit can be made portable between the two pre-paid systems. The transfer of credit will occur in one of three ways depending on the pre-paid technology used by the networks.

a) Where both HN and VN use Local Storage based pre-paid systems, credit can be transferred by deducting the amount to be transferred from one credit register, crediting it to the other and settling the balance between the networks.

b) Where the HN uses a Local Storage based prepaid system and the VN uses a Remote Storage based pre-paid system, credit can be transferred

i) from the HN to the VN, by deducting the amount to be transferred from the HNCR and crediting it to the credit balance kept in the VN; and

ii) from the VN to the HN, by deducting the amount to be transferred from the credit balance kept by the pre-paid platform in the VN and crediting it to HNCR on the SIM card; and

iii) settling the balance between the networks.

c) Where the HN uses a Remote Storage based pre-paid system and the VN uses a Local Storage based pre-paid system, credit can be transferred

i) from the HN to the VN, by deducting the amount to be transferred from the credit balance kept in the HN and crediting it to the VNCR on the SIM card; and

ii) from the VN to the HN, by deducting the amount to be transferred from the VNCR and crediting it to the credit balance kept in the HN; and

iii) settling the balance between the networks.

Deducting an amount to be transferred from a credit register on a SIM card means the pre-paid platform through which the transfer request is made will send a message with instructions to alter the credit either directly to the mobile station or by way of relaying the message via the pre-paid platform in the corresponding network.

Likewise, crediting an amount to be transferred to a credit register on a SIM card means the pre-paid platform through which the transfer request is made will send a message with instructions to alter the credit either directly to the mobile station or by way of relaying the message via the pre-paid platform in the corresponding network.

Settlement between the networks means the cooperating pre-paid platforms send each other authenticated credit notification messages. Intermediate settlement is done in appropriate intervals during the mobile station's visit in the visited network. When the user becomes known to have departed the visited network, the temporary account in that network will be closed and accounts can be finalised and settled between the networks.

In a further alternative embodiment, only one credit register is provided on the SIM card. This register acts as a multi-purpose register that is used as an HNCR while the MS is in the home network and as a VNCR while the MS is roaming in a visited network with a SIM based pre-paid service.

The register's function as HNCR is suspended temporarily in order to release it for use as VNCR while in the visited network. Certain steps need to be undertaken in order to make sure there is no confusion about the balance of the register and what the function of the register is at any given moment.

In an arrangement where both the HN and the VN have SIM based pre-paid service, while the user is in his home network the credit register is used as HNCR and everything works as previously described. The MSC sends CAI during call set up and AoC during call in progress, while the SIM's charging logic deducts the charges from the HNCR accordingly. When credit is zero and CAI is non-zero, the charging logic will not allow the MS to make any calls. Upon a credit notification message the charging logic will update the credit register according to the credit received.

When the user visits another network and tries to sign on, the VN recognizes that a compatible SIM card is present. It sends a message to the HN requesting that the credit register's function as HNCR be temporarily suspended until the user leaves the VN in order to make the register available for use as a VNCR. The HN receives the request and obtains the current credit balance for the MS. The credit balance can be either retrieved from a database or from the logic in the mobile station which will be able to notify the HN of the credit balance on request. The HN stores the credit balance or marks it as “deposited”. The HN will then suspend all functions related to the use of the register—i.e. phone services and recharging. Then the HN will send instructions to the MS to clear the register and for added security also to disregard any charging messages from the HN until the suspension is lifted. The charging logic will clear the register and accept the VN and the local pre-paid platform as its new master.

Once this status is achieved, the credit register on the SIM card is used as the VNCR. The MS will now take part in the local pre-paid service just like any other pre-paid phone. The only difference is that the HN has a forwarding service for inbound calls to the mobile station's number in the HN which are forwarded to the VN. Again these can be charged to the HN account but must be also charged by a remote storage principle or to the local account in the VN if cooperation/settlement is in place.

When the user returns to the HN, the HN will recognise that steps need to be undertaken to sign him off in the VN and to re-establish the SIM's credit register's function as HNCR.

When the user tries to sign on in the HN, the HN will send a message to the VN to request that credit register function as VNCR is terminated because the user has returned to his HN. The VN receives the request and obtains the current balance (either from a database or from the MS) so that the VN can keep the credit for the user for a fixed period of time in case the user visits the VN again. Then the VN will send instructions to the MS to clear the register and for added security, to disregard any charging messages from the VN. The charging logic will clear the register and once again accept the HN and the local pre-paid platform as its master. The HN will lookup the credit balance and sends instructions to the MS to update the credit register accordingly.

Once this status is achieved, the register on the SIM card is once again being used as HNCR. The MS will now again take part in the HN's pre-paid service just like before. The forwarding service is cancelled.

If the user leaves one VN and then visits another VN, the new VN unknowingly will send a message to the HN to ask for the release of the credit register. The HN will then proceed as if the user had returned to the HN. However, it will only go as far as to have the previous VN to release the credit register. The HN will not restore the credit but instruct the MS to accept the new VN as its new master. From then on the system follows the same steps as if the user had been coming from the HN to visit the new VN.

The benefit of this system is simplicity. It is particularly well suited for hybrid pre-paid systems because they can more easily deal with the situation not to have to rely on the register while the MS is visiting another network. Networks with pure local storage systems may have to rely on the visited network to charge for all services and then settle between the networks. In such a situation the following arrangements are likely: a) Where the networks do not want to do any settlement, there will be no inbound call forwarding by the HN, only a change of the voicemail greeting to notify callers of the phone's temporary number; Further, b) once credit has been established in the VN all calls (including inbound forwarded from the HN) are charged in the VN; and c) the VN “purchases” the remaining credit on the card from the HN and all calls (including inbound forwarded from the HN) are charged in the VN.

As discussed above, there may be provided, either as part of the first preferred embodiment or as an alternative to it, an opt-in service for persons who have roaming enabled but who may wish to take advantage of having a local account when in a visited network. For example, upon sign-on to a network offering the service, the user could be asked by a dialog on their phone's screen if they wanted to opt for a cheaper pre-paid based roaming service—in this example, the predetermined condition would be that the user replies positively to the offer. Alternatively, when the user signs on, they could be provided with a short message with instructions as to how to opt for the cheaper pre-paid service. Further, the user may have already nominated with a service bureau that they would be interested in considering the pre-paid roaming service or would like to take up the pre-paid roaming service when they are in a visited network. A further possibility is that the user could nominate that they wished to be offered pre-paid roaming or would like to take up pre-paid roaming automatically in certain networks.

Once the user has opted for pre-paid roaming in the visited network, the user can make and receive calls in accordance with one of the techniques described above. If the user's pre-paid account expires or if the user is in an area which is not covered by the pre-paid roaming service, the user can fall back on the traditional roaming service.

The apparatus for allowing a user to select a pre-paid roaming service in a visited network 3 even when they are allowed to roam by the home network 1 can be used independently or in conjunction with apparatus which allows a mobile station which is not allowed to roam by a home network 1 to roam in a visited network. It will be further understood that the apparatus of the two systems can be integrated. In this case, additional queries which are illustrated in FIG. 3 are made to determine whether a temporary account should be created even though the user has traditional roaming enabled.

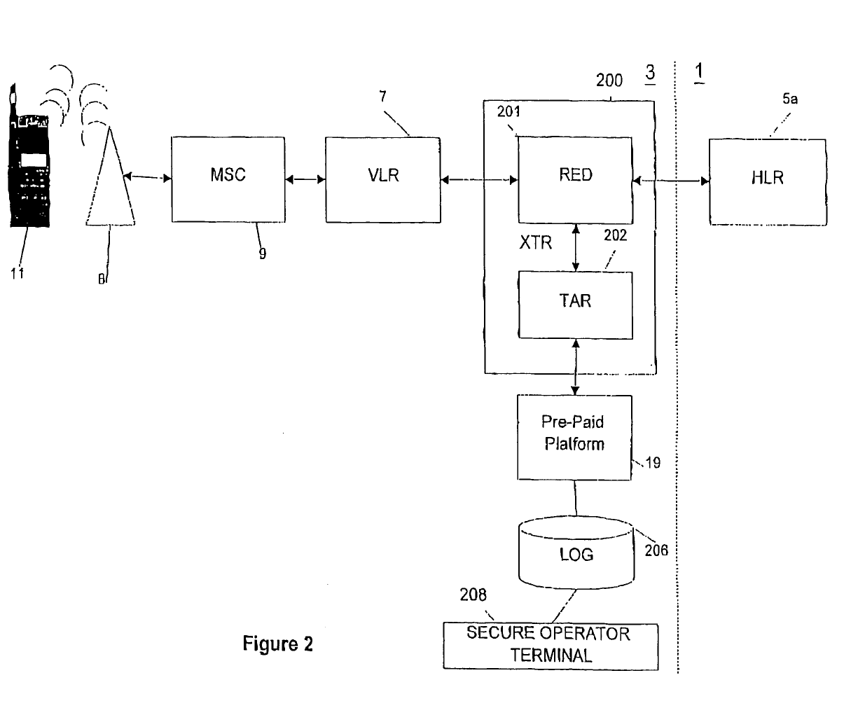

An example of a second preferred embodiment will now be described in relation to FIG. 2. While the second preferred embodiment still requires active interception it can be deemed a more “passive” solution. The apparatus of the second preferred embodiment is particularly suited to enabling two or more networks to establish a cooperative framework in order to allow prepaid roaming in the other networks. This solution is particularly suited to the situation where two or more networks are located within the same country. In the second embodiment, it is envisaged that there will already be in existence a roaming arrangement between the networks such that when a mobile station 11 is roaming in a visited network 3, calls made to it in the home network 1 will be delivered to the MS 11 in the visited network 3. These calls can be charged against the mobile station's prepaid telephone account in the home network. However, because of the aforementioned problems with real time settlement of phone calls made in a visited network by a prepaid phone and the consequent risks to the network operator, the mobile station 11 will not be allowed to make outgoing calls when in the visited network 3. Accordingly, additional apparatus is provided in the form of an extended temporary account registry (XTR) 200. The XTR 200 consists of a roaming event detector (RED) 201 and a temporary account registry (TAR) 202. The RED 201 intercepts signals returned from the HLR 5a which indicate that an MS has a restricted roaming facility—e.g. the MS is not entitled to make outgoing calls and initiates the creation of a local account so that the MS can make outgoing calls. Where a user preferences database is provided, the RED 201 also checks the (UPDB) to determine whether an account should be created. The TAR 202 maintains all relevant data necessary to support the visitor. The difference between XLR 115 of the first embodiment and XTR 200 is, that the XTR's detector (provided by RED 201) ignores any location change related signals and the XTR's registry (provided by TAR 202) does not deal with any location changes. Instead, location updates relating to change of location are dealt with by the HLR in the home network. As a result, the XTR 200 is not capable of serving any visitors for whom roaming is not allowed, however, it can enhance an existing roaming facility—e.g. by allowing outgoing calls where roaming is restricted. In this embodiment the TAR 202 is not updated when the visitor changes location.

When a roaming subscriber switches on their mobile station 11 in visited network 3, the MS 11 initiates a location update. The MSC/VLR 9/7 checks the identity of the mobile station 11 by virtue of its IMSI which is contained in the location update request and deduces that the mobile station 11 is unknown in the service area controlled by the MSC/VLR 9/7. Normally the MSC/VLR 9/7 would request the subscription information for the mobile station 11 from the mobile station's HLR 5a in the home network. In the second preferred embodiment, this request is passed via the RED 201 of XTR 200 which then communicates with the HLR 5a if necessary. The RED 201 checks if the mobile station 11 already has an active account by attempting to locate a record associated with the mobile station's IMSI in the TAR 202. If no profile exists, the TAR 202 of XTR 200 creates one which is indexed by the IMSI and sends a location update request to the mobile station's HLR in the home network.

The HLR 5a accesses the mobile station's subscription by virtue of its IMSI and returns the subscription information to the XTR 200.

The XTR 200 then requests the creation of a temporary account from the prepaid platform 19 and obtains a MSVTLN. In this embodiment, the MSVTLN is not diallable but is used as an account reference. Thus, it will be appreciated that the MSVTLN is passed to the VLR to enable future charges to be allocated to the mobile station's account. Hence, all incoming calls are made to the MS 11 using its home network number MSISDN and are delivered via its mobile station roaming number MSRN.

It will be appreciated, that in the second preferred embodiment, account creation comprises the allocation of a MSVTLN which is used as an account refer nce number, the association of this MSVTLN with the mobile station's IMSI and the creation of a local charging account.

However, it will be appreciated that various of the other charging models discussed in relation to the first preferred embodiment, may be applied in the second preferred embodiment. For example, the prepaid account may be kept on a SIM card as described above. It is also conceivable that rather than a prepaid account, an account may be set up for billing service with the user being required to provide a valid credit card in order to maintain that account. Other techniques for maintaining an account as discussed above may also be applied in the second preferred embodiment—for example, settlement of charges by a sponsor as discussed above.

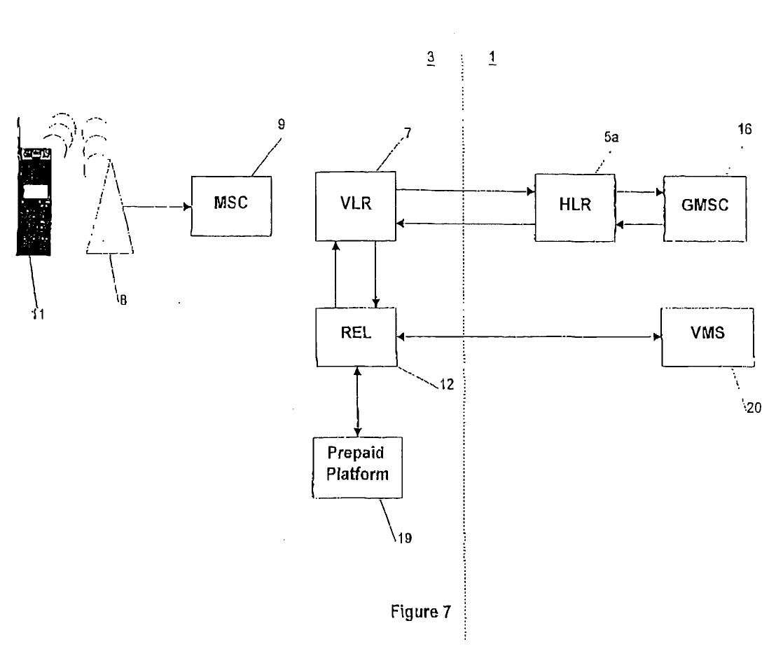

A third preferred embodiment is illustrated in FIG. 7. In FIG. 7, where appropriate the same reference numerals are used as used elsewhere in the specification to identify similar network components. In this embodiment, instead of an XLR, there is provided a roaming event listener REL 12 which does not intercept signalling between the VLR and HLR or indeed between the VLR and the MS. Thus, this embodiment uses passive detection and hence when the HLR 5a returns a signal which indicates that roaming is not allowed, the MS 11 will be denied service. If the HLR 5a returns a signal which indicates that the MS 11 has a restricted roaming facility or a UPDB is implemented and a user preference for creation of a local account is determined from a query of the UPDB, the REL 12 initiates creation of a local account in order to permit the MS 11 to operate fully in the visited network 3.

Creation of the temporary account in this embodiment involves the REL 12 requesting creation of a local account from the prepaid platform 19 and also initiating provisioning for the MS 11 in one or more network elements. For example, the MSC 9 may be provisioned to route calls made by the roaming MS 11 via prepaid platform 19 in order to allow charging to occur. In certain network configurations it may be necessary to modify one or more network elements for such provisioning to be possible.

Again, it will be appreciated that the account maintenance and billing techniques described above can be employed with this embodiment.

It will be appreciated by persons skilled in the art that these are not the only techniques for applying the present invention and that it is possible that a number of other arrangements may be employed to carry out the invention which may require modification to various network elements in order to allow the invention to be carried out.

For example, the functions of the XLR 115 of the first embodiment could be distributed amongst several network elements. For example, a detection device located between the VLR and HLR could initiate the creation of the account, while the MSC/VLR in a typical MSC/VLR co-location, could modify signalling between the home and visited networks so that the MS can sign on.

Persons skilled in the art will appreciate that these and other modifications may be made to the invention without departing from the scope of the invention.

The claims defining the invention are as follows:

1. A method of permitting a mobile station from a home network to operate in a visited network, said method including:
monitoring an attempt by said mobile station to sign on to said visited network to determine whether a predetermined condition is met; and
automatically initiating the creation of an account for said mobile station in said visited network if said predetermined condition is met.

2. A method as claimed in claim 1, wherein said visited network is one of a plurality of visited networks serving a geographic area, and said method involves checking that said mobile station does not have an active account in another visited network within the same geographic area before initiating the creation of an account.

3. A method as claimed in claim 1, wherein said predetermined condition is that said mobile station is not permitted to operate in said visited network.

4. A method as claimed in claim 3, wherein said mobile station is not permitted to operate if it is not entitled to roam in said visited network.

5. A method as claimed in claim 3, wherein said mobile station is not permitted to operate if it is not entitled to make outgoing calls in said visited network.

6. A method as claimed in claim 3, wherein said mobile station is not permitted to operate if it is not permitted to incur charges on behalf of the home network in the visited network.

7. A method as claimed in claim 1, wherein said method involves requesting insertion of an entry for said mobile station in the visitor location registry.

8. A method as claimed in claim 1, wherein creating an account includes maintaining said account if arrangements are made to settle charges incurred by the mobile station in the visited network.

9. A method as claimed in claim 1, wherein creating an account involves allocating a local phone number to said mobile station.

10. A method as claimed in claim 9, wherein said arrangements involve purchasing call credits in the visited network.

11. A method as claimed in claim 9, wherein said arrangements involve transferring call credits from the home network.

12. A method as claimed in claim 9, wherein said arrangements involve a sponsor settling said charges.

13. A method as claimed in claim 12, wherein a user of said mobile station must listen to an advertisement on behalf of said sponsor before incurring a charge to be settled by said sponsor.

14. A method as claimed in claim 9, wherein said arrangements must be made within a time limit.

15. A method as claimed in claim 1, wherein said account is maintained while expiry conditions are not met.

16. A method as claimed in claim 1, wherein said account is closed when said mobile station returns to sign on in said home network.

17. A method as claimed in claim 1, wherein said account is closed when said mobile station signs on in a subsequently visited network.

18. A method as claimed in claim 1, wherein said account is closed when the user of said mobile station makes a request to close said account.

19. A method as claimed in claims 16 and 18, wherein closure of said account involves transferring remaining call credits to said home network.

20. A method as claimed in claims 17 and 18, wherein closure of said account involves transferring remaining call credits to said subsequently visited network.

21. A method as claimed in claims 16, 17 and 18, wherein closure of said account involves reimbursement of remaining call credits to the user of said mobile station.

22. A method as claimed in claims 15, 16, 17 and 18 wherein expiry or closure of said account involves sending a notification to the user of said mobile station.

23. A method as claimed in claim 1, wherein, the method involves providing a credit register for use in said visited network, and creating an account involves activating said credit register so that it can be used in said visited network.

24. A method as claimed in claim 1, wherein a further embodiment, activating said credit register may involve reconfiguring a credit register normally for use in the mobile station's home network for use in the visited network.

25. A method as claimed in claim 1, wherein creating an account includes allocating credit and said arrangements must be made before the allocated credit is consumed.

26. A method as claimed in claim 1, wherein said method includes sending a message to said mobile station after creating said temporary account, said message including information as to how to make said arrangements.

27. A method as claimed in claim 1, wherein the determining step is carried out only when said mobile station is first turned on in said visited network.

28. A method as claimed in claim 1, wherein creating an account involves creating an account with a pre-paid platform.

29. A method as claimed in claim 1, wherein creating an account involves creating an account with a billing system.

30. A method as claimed in claim 1, wherein the monitoring step involves intercepting communications between the visited network and the home network.

31. A method as claimed in claim 30, wherein the intercepting step involves intercepting communications between a visitor location registry (VLR) handling the sign-on attempt in the visited network and the mobile station's home location registry (HLR).

32. A method as claimed in claim 31, wherein said method involves emulating the HLR to the VLR as necessary.

33. A method as claimed in claim 31, wherein said method involves emulating the VLR to the HLR as necessary.

34. A method as claimed in claim 1, wherein said condition is that said mobile station is pre-registered for initiation of creation of an account in said visited network.

35. A method as claimed in claim 34, wherein the monitoring step includes checking a profile associated with said mobile station and determining from said profile whether creation of an account should be initiated for said mobile station.

36. A method as claimed in claim 34, wherein the monitoring step includes checking a profile associated with said mobile station to determine whether creation of an account in the visited network should be offered to a user of said mobile station, offering the connection to said user, and determining from a response to said offer whether an account should be created.

37. A method as claimed in claim 35, wherein said profile is maintained by said home network.

38. A method as claimed in claim 35, wherein said profile is maintained by said visited network.

39. A method as claimed in claim 35, wherein said profile is maintained by a database independent of said home network and said visited network.

40. A method as claimed in claim 35, wherein said checking step involves checking a plurality of profiles.

41. A method as claimed in claim 1, further including automatically configuring a voicemail service in the mobile station's home network, and associated with the mobile station to announce the local number for the mobile station.

42. A method as claimed in claim 41, wherein said voicemail service for said mobile station is reset to the standard announcement when said account is closed.

43. A method as claimed in claim 1, further including automatically activating a call forwarding service in the mobile station's home network.

44. A method as claimed in claim 43, wherein said call forwarding service for said mobile station is deactivated when said account is closed or terminated.

45. A method as claimed in claim 1, further including automatically activating a unified messaging service in the mobile station's home network to thereby forward messages left for said mobile station in said home network to said visited network.

46. A method as claimed in claim 45, wherein said unified messaging service for said mobile station is deactivated when said account is closed or terminated.

47. A method as claimed in claim 2, wherein said method involves checking that said mobile phone does not have an active account with any other visited network irrespective of the location of the visited network, and advising said any other visited network that said mobile station is attempting to sign on in said visited network whereby said any other visited network can close said active account if appropriate.

48. Apparatus for permitting a mobile station from a home network to operate in a visited network, said apparatus including:
monitoring means for monitoring an attempt by said mobile station to sign on to said visited network to determine whether a predetermined condition is met; and
account creation means for automatically initiating the creation of an account for said mobile station in said visited network if said predetermined condition is met.

49. Apparatus as claimed in claim 48, wherein said visited network is one of a plurality of visited networks serving a geographic area, and said apparatus further includes account checking means for checking that said mobile station does not have an active account in another visited network within the same geographic area before said account creation means initiates the creation of an account.

50. Apparatus as claimed in claim 48, wherein said predetermined condition is that said mobile station is not permitted to operate in said visited network.

51. Apparatus as claimed in claim 50, wherein said mobile station is not permitted to operate if it is not entitled to roam in said visited network.

52. Apparatus as claimed in claim 50, wherein said mobile station is not permitted to operate if it is not permitted to incur charges on behalf of the home network in the visited network.

53. Apparatus as claimed in claim 48, wherein said predetermined condition is that said mobile station has a restricted roaming facility.

54. Apparatus as claimed in claim 48, further including local phone number allocation means for allocating a local phone number to said mobile station.

55. Apparatus as claimed in claim 48, wherein said account creation means requests insertion of an entry for said mobile station in the visitor location registry.

56. Apparatus as claimed in claim 48, wherein said apparatus includes account maintenance means for maintaining said account if arrangements are made to settle charges incurred by the mobile station in the visited network.

57. Apparatus as claimed in claim 56, wherein said arrangements involve purchasing call credits in the visited network.

58. Apparatus as claimed in claim 56, wherein said arrangements involve transferring call credits from the home network.

59. Apparatus as claimed in claim 56, wherein said arrangements involve a sponsor settling said charges.

60. Apparatus as claimed in claim 59, wherein a user of said mobile station must listen to an advertisement on behalf of said sponsor before incurring a charge to be settled by said sponsor.

61. Apparatus as claimed in claim 56, wherein said account maintenance means maintains said account while expiry conditions are not met.

62. Apparatus as claimed in claim 56, wherein said arrangements must be made within a time limit.

63. Apparatus as claimed in claim 48, wherein said monitoring means is located between the visited network and the home network.

64. Apparatus as claimed in claim 63, wherein the monitoring means intercepts communications between the visited network and the home network.

65. Apparatus as claimed in claim 64, wherein the monitoring means intercepts communications between a visitor location registry (VLR) handling the sign-on attempt in the visited network and the mobile station's home location registry (HLR).

66. Apparatus as claimed in claim 63, wherein the monitoring means is provided by an extended location registry (XLR).

67. Apparatus as claimed in claim 66, wherein the XLR is configured so as to be transparent to the visited and home networks.

68. Apparatus as claimed in claim 67, wherein said XLR is configured to emulate the home location registry of said home network said visited network as necessary.

69. Apparatus as claimed in claim 68, wherein said XLR is also configured to emulate the visitor location registry of said visited network to said home network as necessary.

70. Apparatus as claimed in claim 66, wherein said XLR is in communication with a local charging platform and initiates the creation of an account by sending an account creation signal to said local charging platform.

71. Apparatus as claimed in claim 70, wherein the local charging platform is a pre-paid platform.

72. Apparatus as claimed in claim 70, wherein said local charging platform is a billing system.

73. Apparatus as claimed in claim 48, wherein said mobile station includes a credit register, and said account creation means is capable activating said credit register.

74. Apparatus as claimed in claim 73, wherein said credit register is located on said mobile station's SIM card.

75. Apparatus as claimed in claim 73, wherein said account creation means activates said credit register by reconfiguring a credit register normally for use in said mobile station's home network for use in the visited network.

76. Apparatus as claimed in claim 48 wherein said predetermined condition is that said mobile station is registered for creation of a local account.

77. Apparatus as claimed in claim 76, wherein said apparatus also includes a user preferences database UPDB which maintains profiles for mobile stations, whereby said apparatus can query said UPDB to determine whether a mobile station attempting to sign on in the home network is registered for creation of a local account.

78. Apparatus as claimed in claim 66, wherein said apparatus also includes means to automatically configure a voicemail service in said mobile station's home network, to change the voicemail greeting for said mobile station.

79. Apparatus as claimed in claim 66, wherein the XLR also initiates the activation of a call forwarding service in said mobile station's home network so that calls made to the mobile station in said home network are forwarded to said mobile station in said visited network.

80. Apparatus as claimed in claim 66, wherein the XLR also initiates the activation of a unified messaging service in said mobile station's home network so that messages left for said mobile station in said home network are forwarded to said mobile station in said visited network.

81. Apparatus as claimed in claim 48, wherein creation of an account by said account creation means involves creating an account reference and associating said account reference with the mobile station's international mobile subscriber identification.

82. Apparatus as claimed in claim 53 wherein said mobile station has a restricted roaming facility if said mobile station is not entitled to make outgoing calls in said visited network.

83. Apparatus as claimed in claim 48, further including a registry for maintaining data relating to mobile station's for which an account has been created.

84. Apparatus as claimed in claim 48, wherein said apparatus further includes account closure means for triggering closure of said account.

85. Apparatus as claimed in claim 84, wherein said account closure means is triggered when said mobile station returns to sign on in said home network.

86. Apparatus as claimed in claim 84, wherein said account closure means is triggered when said mobile signs on in a subsequently visited network.

87. Apparatus as claimed in claim 85, wherein said account closure means is triggered when the user of said mobile station makes a voluntary request to close said account.

88. Apparatus as claimed in claim 84, wherein said apparatus is configured to forward remaining credit for said mobile station to said home network in the event of said account closure or in the event of expiry of said account.

89. Apparatus as claimed in claim 84, wherein said apparatus is configured to forward remaining credit for said mobile station to said subsequently visited network in the event of said account closure.

90. Apparatus as claimed in claim 84, wherein said apparatus is configured to reset a voicemail service in said home network for said mobile station to the standard greeting in the event of said account closure or in the event of expiry of said account.

91. Apparatus as claimed in claim 84, wherein said apparatus is configured to deactivate a call forwarding service in said home network for said mobile station in the event of said account closure or in the event of expiry of said account.

92. Apparatus as claimed in claim 84, wherein said apparatus is configured to deactivate a unified messaging service in said home network for said mobile station in the event of said account closure or in the event of expiry of said account.

93. Apparatus as claimed in claim 84, further including means to send a message to the user of said mobile station with a notification when said account has been closed or terminated.

94. Apparatus as claimed in claim 49, wherein said account checking means checks that said mobile phone does not have an active account with any other visited network irrespective of the location of the visited network, and wherein said account checking means advises said any other visited network that said mobile phone is attempting to sign on in said visited network whereby said any other visited network can close said active account if appropriate.
